(19) United States
(12) Patent Application Publication
(10) Pub. No.: US 2015/0124080 A1
(43) Pub. Date: May 7, 2015

(54) Method and device for scanning a film

(71) Applicant: Digital Film Technology GmbH, Darmstadt (DE)

(72) Inventors: Markus HASENZAHL, Riedstadt (DE); Peter John VIRTUE, Sydney (AU)

(21) Appl. No.: 14/531,002

(22) Filed: Nov. 3, 2014

(30) Foreign Application Priority Data
Nov. 4, 2013 (DE) 102013018430.4

(51) Int. Cl. H04N 5/253; H04N 5/232

(52) U.S. Cl. CPC H04N 5/253; H04N 5/23212
USPC 348/97

(57) ABSTRACT

A method and apparatus for scanning a film, in which the film is illuminated by a light source and the light signal coming from the film is fed in channels to a plurality of imaging devices each defining a channel, wherein an exposure for the channels is adjusted to achieve different exposures of the film in at least two of the channels. The signal recorded by the imaging devices is stored as an image having a high dynamic range.

### CROSS-REFERENCE TO RELATED APPLICATIONS

This application claims priority under 35 U.S.C. §119(b) of German Patent Application No. 102013018430.4 filed Nov. 4, 2013, the entire disclosure of which is incorporated herein by reference for all purposes.

### FIELD OF THE INVENTION

The invention relates to a method for scanning a film, a use of a film scanner and a device for scanning a film.

### BACKGROUND OF THE INVENTION

Devices for scanning a film, commonly referred to as a film scanner, are used, inter alia, to generate signals in order to read images stored on the film and/or to store such images on a storage medium.

DE 101 15 342 A1 discloses a device for scanning films, in which a film is exposed by an illuminating device. A line of the film is reproduced on three sensors by means of an objective lens, wherein a color splitter assigns the respective color component to the sensors, which color components are fed as corresponding R, G, B signals to a video processing circuit by means of an amplifier. All of the color video information can be extracted in a suitable format at the output of the video processing circuit and appropriately stored.

### SUMMARY

The object of the invention is to largely avoid the over- and underexposure of the film, in particular in the case of black-and-white film, wherein image details are better preserved during the scanning and more extensive image editing can be performed. The signal-to-noise ratio for high-density areas can be improved.

The core idea underlying the invention is that the channels with the respectively associated imaging device are not used to separate color separations of a color film, but instead are used to separate different density ranges of the film. Thus in particular a film can be scanned that contains no varying color information. The method and the device may therefore in particular relate to the scanning of a black-and-white film. The signals generated by the image processing devices may be combined into a black-and-white HDR image, in which over- and underexposure is largely avoided, image details are better preserved, and/or more extensive image editing can be performed, in a single process step.

The process step may be part or all of a control system, which controls the device according to the invention and/or which provides commands for the implementation of the method according to the invention. The control system may be embodied in a control unit and may be connected to the illumination and/or the imaging devices. The control unit may be a processor or the like, on which commands for the adjustment of the illumination and/or imaging devices are available. The control unit may also store the image information from the imaging device on a suitable storage medium.

In the case of the method for scanning a film according to the invention, the film is illuminated by a light source and the light signal coming from the film is fed in channels to a plurality of imaging devices. The film is illuminated by the light source and lines of the film are reproduced on the imaging devices. The exposure is adjusted for the channels in such a way that different exposures of the film are achieved in at least two channels. The signal recorded by means of the imaging devices is stored for an image having a high dynamic range, or in other words an HDRI, High Dynamic Range Image. A high dynamic range image is a high-contrast image, or in other words a digital image, which reproduces large differences in brightness in great detail.

According to the invention, the term “film” refers to a scanning medium having image information, or in other words a photographic film strip in a defined film format.

According to the invention, the term “light source” refers to an electrical apparatus, which is used to generate light. The use of the term “light source” also includes the use of the term “light sources” in the plural. The use of the term “a light source” also encompasses “a plurality of light sources.” In particular the term “light source” also encompasses one or a plurality of LEDs. In addition, the term “light source” also refers to a panel of electroluminescent film and/or incandescent and gas discharge lamps.

According to the invention, the term “channel” refers to an optical path from the light source to the imaging device. In particular, the term “channel” refers to the provision of a distribution of light signals, in particular by providing a beam splitter. The beam splitter may, in particular, be designed as a color splitter. Insofar as the beam splitter is designed as a color splitter, the channels in the case of color film correspond to the individual color separations, each of which is assigned to a respective imaging device.

According to the invention, the term “imaging device” refers to image sensors and/or cameras. The image sensors may be light sensitive, electronic components, which in particular, may be CCD image sensors. It may be provided that an image sensor is used, which enables the separation through the use of color filters in front of a chip having a plurality of lines. In this case, a beam splitter/color splitter maybe dispensed with. The channels are “generated” by color filters in front of the one chip.

According to the invention, the device for generating the individual channels of the light beam may be a color splitter or, respectively, a color spectrum splitter, as is known from DE 101 15 342 A1 for example. The color spectrum splitter is not used to generate different color separations from the light signal, which is present after light is passed through the scanning medium however, but instead is used to carry out a variable exposure in the different channels.

In order to generate a variable exposure in individual channels, it may preferably be provided that at least one LED is used as a light source. A plurality of LEDs may be provided and the LEDs can be operated individually or in groups. It may be provided that the illumination generates a light signal, which provides separately adjustable color separations. Color separations with which the film is illuminated can be adjusted by means of the illumination. This may occur, for example, through the use of one or a plurality of filters and/or one or a plurality of LEDs emitting a specific spectral frequency of the light. If the brightness of the color separations of the illumination is adjusted differently, the film may be varyingly exposed in the channels. The illumination can make a separate light adjustment possible for the color separations.

In a preferred embodiment, the light source can be operated in a pulsed manner, whereby the illumination or, respectively, the light source is actuated via a pulse-to-pause ratio. In this way, a light control can be achieved and an exposure adjusted.

It may also be provided that a TDI CCD is used in an imaging device as an imaging sensor. A TDI CCD image sensor is a time delay integration charge-coupled device. A TDI CCD image sensor allows an incremental adjustment of the sensitivity in that the number of integration times can be selected.

The possibility of adjusting separate color separations by means of the illumination, the pulsed actuation of the light source and/or the use of TDI CCDs as image sensors allow the extensive exposure control of the film. The three options for controlling the sensitivity can be measured using a calibration procedure, wherein the signal recorded from each imaging device is identified. In so doing, the light source and/or the TDI CCD can be actuated as a function of the signal measured during calibration during the scanning of a film.

During the scanning of a film, preferably no change is made to the illumination during the readout and storage of the light signal recorded by means of the imaging devices for an image having a high dynamic range.

The inventors have recognized that a film scanner for scanning a film, which in particular contains color image information, which scanner comprises an illumination having a light source as well as a plurality of imaging devices for different channels (for the color separations), can be used in such a way that the film scanner can be used for variable exposures in at least two of the channels and for the storage of the signal from the imaging device in order to generate an image having a high dynamic range, in particular for a black-and-white film.

According to the patent, a device for scanning a film is achieved having an illumination, which comprises a light source. The device likewise has a plurality of imaging devices for different channels. A control system is provided, which is designed in such a way that a variable exposure is undertaken in at least two of the channels, and the signal from the imaging devices is stored for an image having a high dynamic range.

At least one LED is provided as a light source, by means of the control of which, different color separations can be adjusted to by means of the illumination in order to expose the film.

The control system can be designed in such a way that the light source can be actuated in a pulsed manner via a pulse-to-pause ratio. The term, “pulse-to-pause ratio”, refers to a pulsed operation (duty cycle).

In order to control the exposure, an image sensor in the imaging devices may be designed as a TDI CCD, which allows an incremental adjustment of the sensitivity.

At least a part of the control of the illumination and/or of the imaging devices, in order to adjust variable exposures in the channels, is preferably done at least partially on the basis of an FPGA (Field Programmable Gate Array).

An FPGA is a hardware component, that is, an integrated circuit, in which a logical circuit can be programmed. The programming of the FPGA may be designated as code or firmware. The use of an existing, programmable FPGA having a high bandwidth for processing allows a flexible switchover to the HDR function without limiting the previous scanning speed.

The invention is explained in greater detail in the following on the basis of an embodiment depicted in the drawing.

### BRIEF DESCRIPTION OF THE FIGURES

The drawing shows:

FIG. 1 a schematic illustration of the device according to the invention.

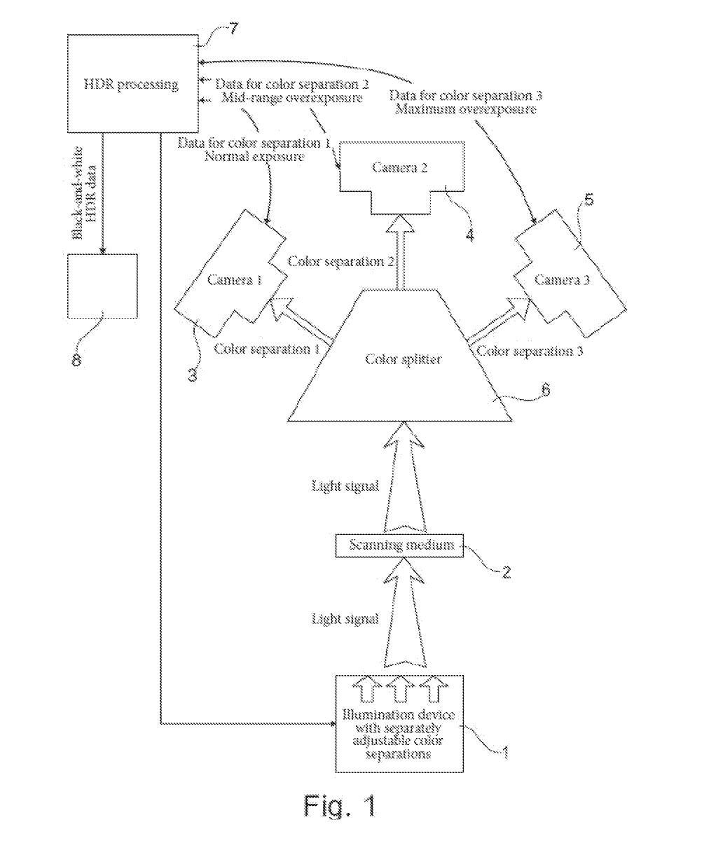

The sole FIGURE shows a device according to the invention, with which a method according to the invention may also be implemented. The sole FIGURE shows necessary elements of a film scanner having three channels, merely for an understanding of the invention. A film 2 is illuminated by an illumination 1, which is designed as an illumination device. In so doing, the film 2 can be transported from a supply spool, via a first roller, a film window and a second roller to a take-up spool.

### DETAILED DESCRIPTION OF THE INVENTION

The respective lines of the film 2 provided for scanning can be reproduced on imaging devices 3, 4, 5 by means of an objective lens. A color splitter 6 is provided, which is designed as a color spectrum splitter, and which assigns the color components to the imaging devices 3, 4, 5, for example as R, G, B signals.

In the case of a black-and-white film as a scanning medium or, respectively, film 2, the channels are not used for the individual color separations, but instead for a variable exposure in the channels.

A normal exposure may be adjusted to in the channel that is assigned to the imaging device 3, for example. A mid-level overexposure may be adjusted to in the channel that is assigned to the imaging device 4, for example. A maximum overexposure may be adjusted to in the channel that is assigned to the imaging device 5, for example.

The data from the imaging devices 3, 4, 5 is fed to a control system 7, which stores the data recorded by the imaging devices 3, 4, 5 as HDR data of a black-and-white image on a storage medium 8.

The control system 7 may be connected to the illumination 1 and/or each of the imaging devices 3, 4, 5 in such a way that the control system 7 actuates the illumination 1 and/or the imaging devices 3, 4, 5. The illumination 1 can be actuated by means of the control system 7 in such a way that the scanning medium or, respectively, the film 2 can be illuminated by means of adjustable color separations. The image sensors of the imaging devices 3, 4, 5 can be actuated by means of the control system 7 in such a way that an incremental adjustment of the sensitivity is achieved in that the number of the integration times is selected by the control system 7 and adjusted in the sensor. In addition, the light source and/or the light source of the illumination 1 can be controlled by means of a pulse-to-pause ratio. This results in three options or, respectively, adjustment screws for controlling the sensitivity, which can be measured in a calibration process and actuated as a function of the required illumination value.

In the depicted embodiment, the exposure can be separately adjusted for the different color separations. The exposure can be adjusted by controlling the illumination, since this allows a variation of the light intensity for the individual color separations. In addition, the shutter or changes in the integration times can also create the exposure variation of the image sensors.

In the case of the scanning of a black-and-white film, in the depicted embodiment, the image sensor of one color separation is normally exposed and at least one image sensor of a further color separation is overexposed. The color channels of the film scanner are thus not used to separate the color separations of the film, but instead are used to separate different density ranges of the film material, which exists as black-and-white film. The signals of the varyingly exposed image sensors are then merged in a process step into an HDR black-and-white image.

1. A method for scanning a film comprising:
illuminating the film with a light source to produce a light signal;
receiving said light signal at a plurality of imaging devices, each imaging device defining a channel;
adjusting an exposure of at least one of said channels to produce different exposures of the film in at least two of said channels;
generating, in said plurality of imaging devices, image data indicative of said different exposures of the film; and
combining said image data from said plurality of imaging devices and storing said combined image data on a storage medium as a high dynamic range image (HDRI).

2. The method according to claim 1, wherein the light signal produced by illuminating said film is split by a color spectrum splitter.

3. The method according to claim 1, wherein said light source comprises at least one light emitting diode (LED), wherein said at least one LED is adjustable to produce color separations with which the film is illuminated.

4. The method according to claim 1, wherein said light source is configured to be operated in a pulsed manner.

5. The method according to claim 1, wherein at least one of said imaging devices comprises an image sensor comprising a time delay integration charge coupled device (TDI CCD).

6. The method according to claim 1, further comprising:
identifying and measuring said light signal at each of said plurality of imaging devices;
calibrating one of said light source and at least one of said imaging devices based on said light signal measured at said imaging devices.

7.-8. (canceled)

9. A device for scanning a film comprising:
a source of illumination comprising a light source;
a carrier for receiving said film and positioning said film relative to said source of illumination;
a plurality of imaging devices, each imaging device of said plurality of imaging devices defining a channel and configured to sense a light signal generated by an illumination of said film by said source of illumination; and
a control system in communication with said source of illumination and said plurality of imaging devices, configured to control an exposure of said film, by actuation of at least one of said source of illumination and at least one of said imaging devices, to produce a variable exposure of said film in at least two of said channels, to receive image data from said plurality of imaging devices, and combine and store the received and combined image data as a high dynamic range image.

10. The device according to claim 9, wherein said source of illumination comprises at least one light emitting diode (LED) as a light source, said at least one LED configured to provide different color separations for exposing the film based on actuation of the at least one LED by said control system.

11. The device according to claim 9, wherein the control system is configured to actuate the source of illumination in a pulsed manner.

12. The device according to claim 9, wherein at least one of said plurality of imaging devices comprises at least one image sensor, said at least one image sensor comprising a time delay integration charge coupled device (TDI CCD).

13. The device according to claim 9, wherein the control system is implemented in an integrated circuit.

14. The device according to claim 13, wherein said integrated circuit comprises a field programmable gate array (FPGA).

15. The method according to claim 1, wherein adjusting an exposure of at least one of said channels comprises controlling an actuation of a shutter of at least one of said imaging devices.

16. The method according to claim 1, wherein adjusting an exposure of at least one of said channels comprises controlling a number of integrations of at least one of said imaging devices.

17. A device for scanning a film containing a black and white image, the device comprising:
an illumination source comprising a light source, said illumination source positioned relative to said film;
a plurality of imaging devices positioned so that said film is between said plurality of imaging devices and said illumination source, wherein each imaging device of said plurality of imaging devices defines a channel;
a control processor in communication with said illumination source and each imaging device, said control processor configured to provide actuation signals to at least one of said illumination source and an imaging device of said plurality of imaging devices and to receive and combine image signals from said plurality of imaging devices to generate a high dynamic range image;
wherein said control processor is configured to produce variable exposures of the film in at least two of said channels.

18. The device of claim 17, wherein said image sensor is configured as a time delay integration charge coupled device (TDI CCD).

19. The device of claim 18, wherein said control processor is configured to control an exposure in one of said channels by providing an actuation signal to one of said illumination source and at least one of said plurality of imaging devices.

20. The method according to claim 19, wherein controlling an exposure in one of said channels comprises controlling an actuation of a shutter of said at least one imaging device.

21. The method according to claim 19, wherein controlling an exposure in one of said channels comprises controlling a number of integrations of said at least one imaging device.
